(19) United States
(12) Patent Application Publication
(10) Pub. No.: US 2004/0221007 A1
(43) Pub. Date: Nov. 4, 2004

(54) Smart control points

(76) Inventors: Bryan Y. Roe, Camas, WA (US); Ylian Saint-Hilaire, Hillsboro, OR (US); Nelson F. Kidd, Tigard, OR (US); James W. Edwards, Portland, OR (US)

Correspondence Address: BUCKLEY, MASCHOFF, TALWALKAR LLC, 5 ELM STREET, NEW CANAAN, CT, 06840, US

(21) Appl. No.: 10/427,377

(22) Filed: May 1, 2003

(51) Int. Cl. G06F 15/16

(52) U.S. Cl. 709/203

(57) ABSTRACT

According to some embodiments, provided are reception of a filter from a client application, the filter describing a requested object, discover of the requested object on a network, and instantiation of a local object corresponding to the requested object.

### BACKGROUND

Many types of consumer electronic and personal computing equipment are currently available to the consumer. Conventionally, most of this equipment operates in a standalone mode that does not allow for interaction with other equipment. It is desired to network this equipment so that certain resources may be shared therebetween.

In view of the foregoing, network protocols that provide discoverable services have been proposed. One such protocol, Universal Plug and Play (UPnP), has been defined by companies and individuals comprising the UPnP Forum. UPnP is designed to provide automatic discovery and seamless usage of services offered by many different types of networked equipment. More particularly, one piece of equipment may use UPnP to dynamically join a network, obtain an IP address, convey its capabilities, determine the capabilities of other equipment on the network, and access the capabilities of the other equipment.

The one piece of equipment may use a UPnP control point to determine and access the capabilities of the other equipment. The control point is usually implemented by an equipment developer. At present, an efficient system for implementing a control point is desired. Also desired are new services and usages that provide greater functionality to a network protocol that provides discoverable devices.

### BRIEF DESCRIPTION OF THE DRAWINGS

FIG. 1 is a block diagram of a network architecture according to some embodiments.

FIG. 2 is a block diagram of network apparatuses and object abstractions according to some embodiments.

FIG. 3 illustrates an object hierarchy of a device according to some embodiments.

FIG. 4 illustrates an object hierarchy of a control point according to some embodiments.

FIG. 5 is a network diagram to illustrate device management according to some embodiments.

FIG. 6 is a flow diagram of process steps according to some embodiments.

FIG. 7 is a flow diagram of process steps according to some embodiments.

FIG. 8 is a flow diagram of process steps according to some embodiments.

FIG. 9 is a network diagram to illustrate a memory service according to some embodiments.

FIG. 10 is a flow diagram of process steps to interface with a memory service according to some embodiments.

FIG. 11 is a flow diagram of process steps to provide a memory service according to some embodiments.

FIG. 12 is a network diagram to illustrate content directory management according to some embodiments.

FIG. 13 is a flow diagram of process steps to provide content directory management according to some embodiments.

### DETAILED DESCRIPTION

Components and operation of a network are described below in terms of the UPnP protocol. However, some embodiments may be implemented in conjunction with other components and/or network protocols.

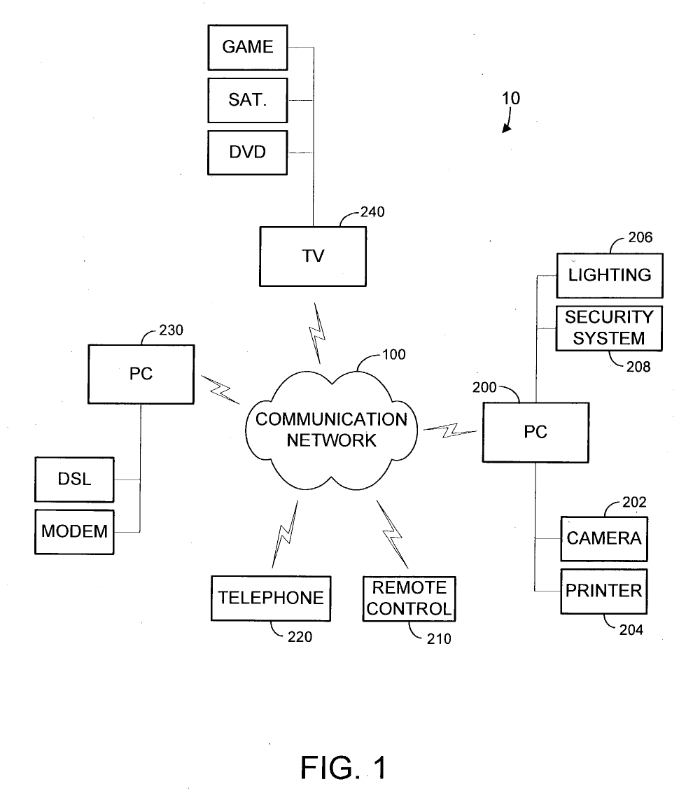

FIG. 1 illustrates an architecture of network 10 according to some embodiments. Network 10 may be located within a home, and the apparatuses of network 10 may be provided by several different vendors. As described above, UPnP allows a network apparatus to discover and use services provided by another network apparatus. Therefore, each UPnP-enabled apparatus of network 10 may discover and use services provided by each other UPnP-enabled apparatus.

Communication network 100 provides communication between apparatuses such as personal computer 200, remote control 210, telephone 220, personal computer 230 and television 240. Communication network 100 may comprise any number of different systems for transferring data, including a Local Area Network (LAN), a Metropolitan Area Network (MAN), a Wide Area Network (WAN), a proprietary network, a Public Switched Telephone Network (PSTN), a Wireless Application Protocol (WAP) network, a wireless LAN (e.g., in accordance with the Institute of Electrical and Electronics Engineers 802.11 standard), a Bluetooth network, an Infrared Radiation (IR) network, and/or an IP network such as the Internet, an intranet or an extranet. The physical layers utilized by these systems may include one or more of any readable medium for transferring data, including coaxial cable, twisted-pair wires, fiber-optics, RF, infrared and the like. Accordingly, communications referred to herein may include wired and/or wireless communications as appropriate.

Personal computer 200, personal computer 230 and television 240 may communicate directly with associated peripheral apparatuses. Communication with the peripheral apparatuses may proceed over any of the above-mentioned systems. In one example, personal computer 200 may communicate with camera 202 via a USB port, with printer 204 via a parallel interface, with lighting 206 via an AC power connection, and with security system 208 via a serial interface. Additionally, each peripheral apparatus of network 10 may communicate directly with each other apparatus.

The elements of FIG. 1 may be connected differently than as shown. For example, any combination of wired or wireless connections may be used, with some apparatuses being connected to network 10 via multiple network connections. Embodiments may also include apparatuses that are different from those shown. Although the apparatuses shown are in communication with each other, the apparatuses need not be constantly exchanging data. Rather, communication may be established when necessary and severed at other times or always available but rarely used to transmit data. Moreover, although the illustrated communication links appear dedicated, it should be noted that each of the links may be shared by other apparatuses.

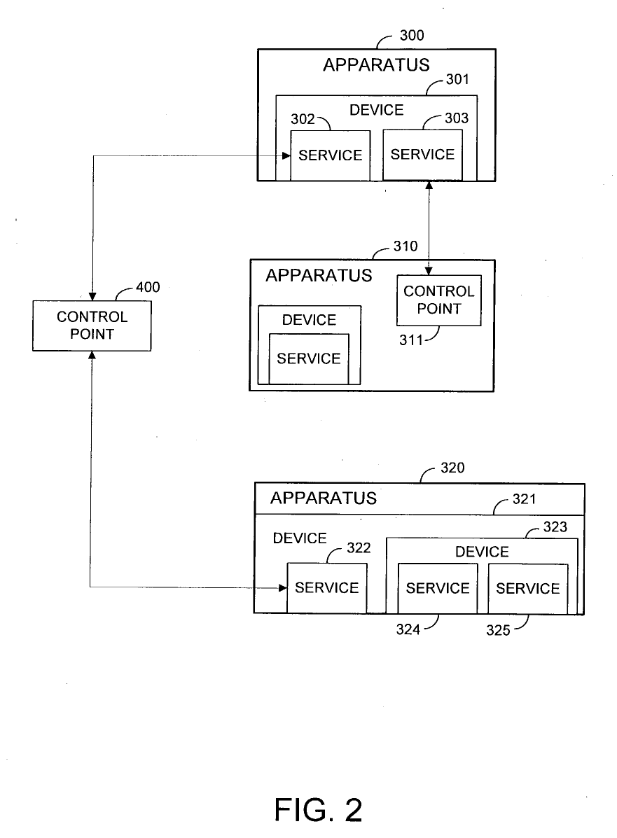

FIG. 2 is a block diagram of network apparatuses and object abstractions according to some embodiments. FIG. 2 illustrates apparatuses 300 through 320, each of which represents a physical unit, such as a personal computer, a television, a digital camera, or any other suitable unit. Each apparatus includes at least one device. A device is an object that is abstracted within an apparatus. A device may contain services and/or other device objects. A service is an object that is abstracted within a device.

As shown in apparatus 300, an apparatus may include a single device, and each device may include several services. In one example, apparatus 300 is a video cassette recorder, device 301 is a video cassette recorder device, service 302 is a tape transport service, and service 303 is a tuner service. In contrast, apparatus 320 may be a combination television/video cassette recorder apparatus that includes television device 321 and tuner service 322. Television device 321 may also include videocassette recorder device 323 and its associated services 324 and 325.

The services provided by a particular type of device differ among device types. Accordingly, a device hosts an eXtensible Markup Language (XML) description document that describes the services provided by the device as well as other associated information.

Each service exposes actions to UPnP control points and models its state using state variables. As a particular example, a clock service may provide the actions get_time and set_time, and may model its state using the state variable current_time. The actions and state variables are described by an XML service description document. The aforementioned XML description document includes a pointer to the service description documents of its associated services.

Control point 400 of FIG. 2 is shown in communication with service 302 and service 322. Control point 400 may be embedded in an apparatus such as control point 311 of apparatus 310. As shown, a control point may access actions of services that are embedded in disparate devices (and apparatuses).

A control point is used to discover and control devices in a UPnP network. In some embodiments, a control point may discover a device, receive an XML description associated with the device, retrieve descriptions of services associated with the device based on pointers located in the description, invoke actions specified in the service descriptions, and subscribe to events issued by the services. In the latter regard, a service will send an event to the control point when a state of the service changes.

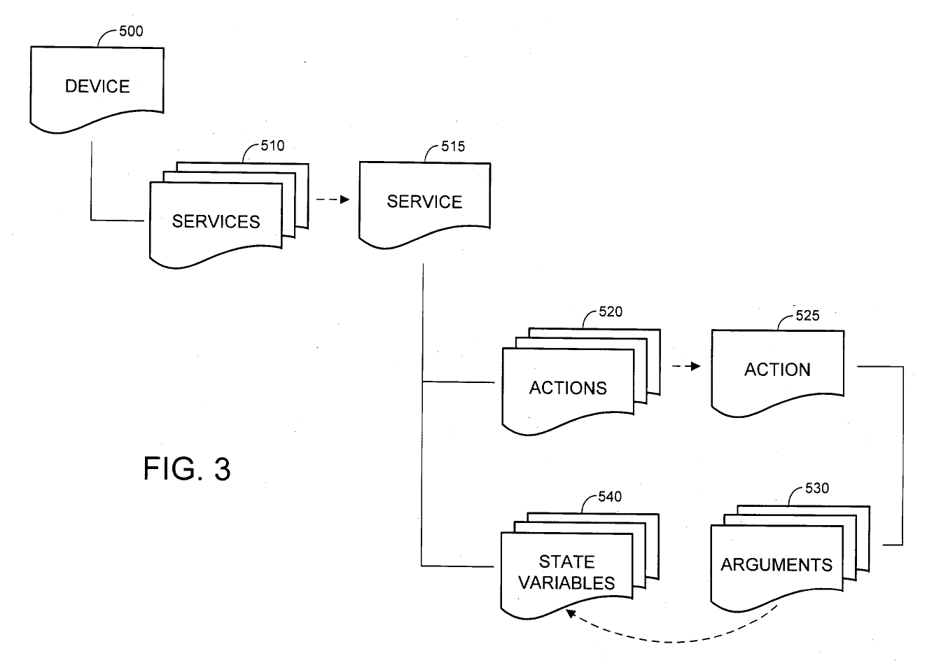

FIG. 3 provides a more detailed view of an object hierarchy according to some embodiments. As shown, device object 500 includes several service objects 510. Device object 500 may be a root device or an embedded device.

A device class used to instantiate a device object according to some embodiments may include CreateRootDevice and CreateEmbeddedDevice methods. Moreover, a service may be added to a device object using an AddService method of the device object to which the service is to be added. Similarly, an embedded device may be added to a device object by calling an AddDevice method of the device object in which the device is to be embedded.

In some embodiments, device object 500 is started by calling a StartDevice method. In response, device object 500 binds to network interfaces that are available to it, monitors a network card, and binds to and advertises on ever-changing IP addresses. Device object 500 may also introspect its object hierarchy to build its associated XML description document.

Service object 515 of services 510 may comprise a container for a group of exposed methods. Service object 515 may be exposed by initially implementing a class that includes the methods to be exposed. This class is passed as a parameter to a constructor in order to instantiate service object 515. An AddMethod method may then be called for each method to be added to service object 515. The AddMethod method may introspect the passed class, find a specified method, create an action object corresponding to the specified method such as action object 525 of action objects 520, and set a function pointer to the specified method. The created action object may therefore be an abstraction of the specified method exposed by the service object.

In some embodiments, the AddMethod method introspects the method and builds argument objects such as argument objects 530 of FIG. 3. Moreover, the AddMethod AddMethod may build state variable objects such as objects 540 to associate with the argument objects. The created action object may then be added to the proper service object. Alternatively, AddAction and AddStateVariable methods may be called to create the above-described objects.

Some embodiments provide automatic generation of a service description document for the created service object based on the class that includes the implemented methods. These embodiments may provide accurate service description documents for use by remote control points.

One or more of the foregoing named methods may be provided to a developer within a software developer's kit. More specifically, the methods may be embodied in processor-executable process steps stored on a medium such as an installation CD-ROM, a floppy disk, or a signal.

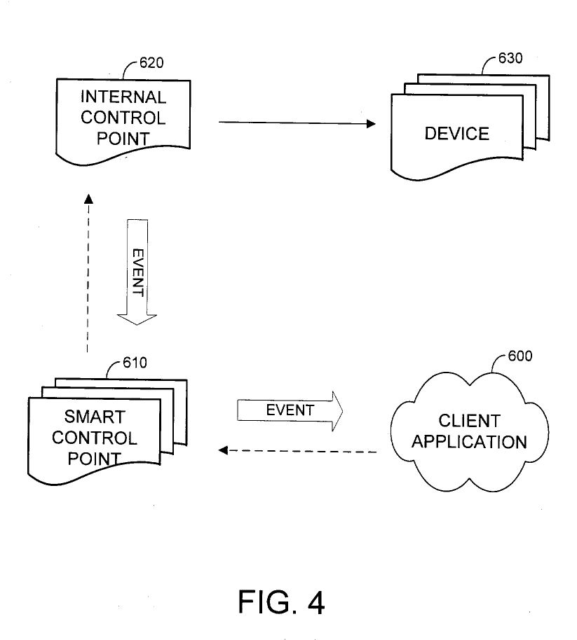

FIG. 4 illustrates an object hierarchy of a control point according to some embodiments. A control point may be used to discover devices and services on a UPnP network. FIG. 4 shows interactions between client application 600 and smart control point object 610 according to some embodiments.

Smart control point object 610 refers to static internal control point object 620, which in turn refers to a control point object (not shown). The control point object may provide discovery of devices and services, as well as reception of notifications, while internal control point object 620 may track discovery and notification messages, and may instantiate an object hierarchy for a discovered device. Device objects 630 represent three of these instantiated hierarchies, each of which may comprise the objects illustrated in FIG. 3.

Smart control point object 610 may accept filters from client application 600. A filter specifies a device or a service which client application 600 wishes to access. If no filter is received from client application 600, smart control point object 610 discovers all root devices. If one or more filters are received, smart control point object 610 will discover any devices that include each device object and/or service object specified by the one or more filters.

Once a device is discovered and an associated device object is instantiated among device objects 630, all traffic intended for the device object's hierarchy may flow through the device object. If smart control point object 610 determines that the device is no longer available, smart control point 610 may send an OnRemoved event to client application 600. If smart control point object 610 determines that the device has migrated to a new network interface, smart control point 610 sends an OnUpdated event to client application 600.

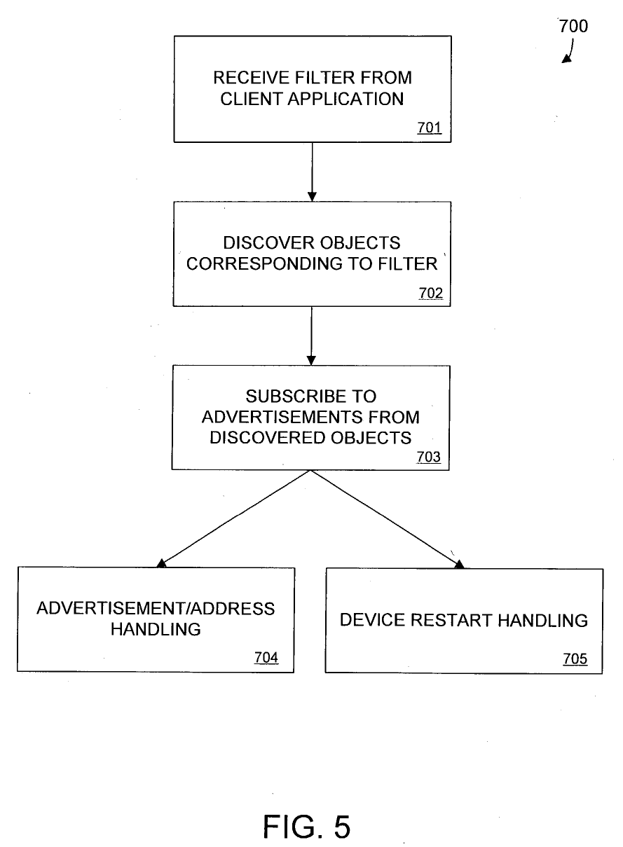

The FIG. 4 hierarchy may provide management of network interfaces and/or device lifetimes to client application 600. FIG. 5 is a flow diagram of process 700 to provide such management according to some embodiments. Process 700 may be embodied in processor-executable code of a software developer's kit as described above, and may be executed by a processor of an apparatus that includes an embedded control point. Other implementations will be evident to those of ordinary skill in the art.

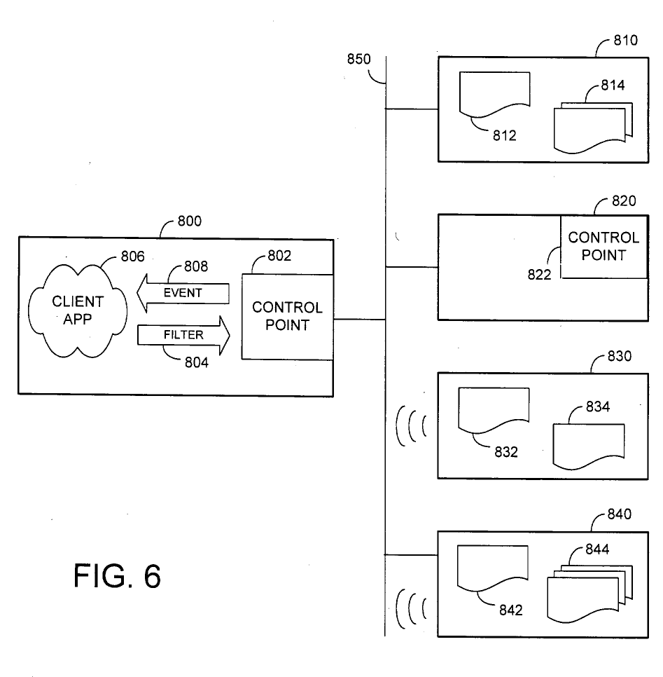

Process 700 begins at 701, in which a filter is received from a client application. In this regard, FIG. 6 is a network diagram for illustrating device management according to some embodiments of process 700. FIG. 6 shows apparatus 800, in which control point 802 receives filter 804 from client application 806. In the present example, filter 804 specifies a device and a service to which client application 806 desires access.

Control point 802 may follow the object hierarchy of FIG. 4. Accordingly, in 701, client application 806 may instantiate a smart control point object for control point 802 and pass filters that specify requested objects to the smart control point object.

Objects corresponding to the received filter are discovered in 702. FIG. 6 shows several objects that may be discovered in 702. More specifically, FIG. 6 shows apparatuses 810 through 840 in communication with each other and with apparatus 800 over network bus 850. Network bus 850 may comprise any one or more physical network layers carrying any one or more network protocols.

Apparatus 810 includes device object 812 and associated service object 814, apparatus 820 includes control point object 822, apparatus 830 includes device object 832 and associated service object 834, and apparatus 840 includes device object 842 and associated service object 844. Apparatus 840 may communicate with network bus 850 over two network interfaces, one wired and one wireless. Apparatuses 810 through 840 may be located local to or remote from apparatus 800, as long as each apparatus is in communication with at least one other apparatus so as to form a network.

In some embodiments of 702, control point 802 may multicast a discovery message using Simple Service Discovery Protocol. The message includes search criteria that identify the objects specified in the filter received from client application 806. Each device of apparatuses 810 through 840 listens for this message over network bus 850. Any device that matches the search criteria or that includes a service matching the search criteria transmits a response to the IP address of control point 802.

Each response identifies a matching object and includes a pointer to an XML description that is associated with the matching object. According to the present example, device 840 and service objects 814 and 834 match the search criteria of the message 804. Therefore, control point 802 receives pointers to XML descriptions associated with objects 840, 814 and 834 in 702. Control point 802 may filter out any received duplicative pointers. A smart control point object of control point 802 may pass event 808 to user application 806 after objects specified by filter 804 are discovered.

Prior to 703, control point 802 uses the received pointers to request an XML description associated with each matching object. Based on the descriptions, control point 802 builds a hierarchy of device and service objects such as that shown in FIGS. 3 and 4. The descriptions also include pointers to service descriptions associated with services 814 and 834. Control point 802 access these service descriptions to determine actions, arguments, and state variables associated with the services. These actions, arguments and state variables are added to the already-created object hierarchies for services 814 and 834 as shown in FIG. 3.

Control point 802 subscribes to advertisements from the discovered objects in 703. In this regard, an advertisement may be an event message that is published by a service when a state variable of the service changes value. Control point 802 may call a Subscribe method of each discovered service object to subscribe to advertisements therefrom in 703. As a result, control point 802 may receive an event message from a discovered service each time a value of an evented state variable of the service changes. The event may be passed to client application 806.

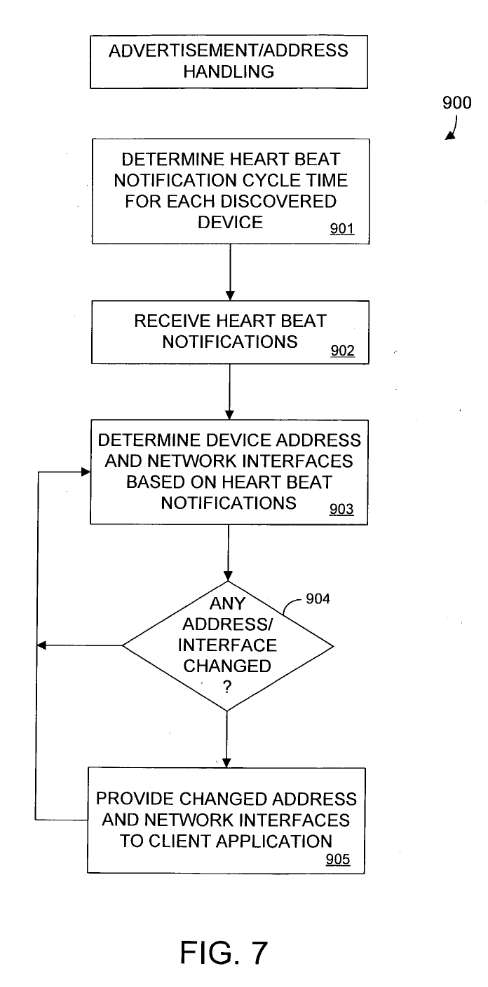

According to some embodiments, control point 802 performs advertisement/address handling in 704. FIG. 7 is a flow diagram of process 900 to perform advertisement/address handling in 704. Control point 802 may implement process 900.

Process 900 begins at 901, in which a heart beat notification cycle time is determined for each discovered device. A heart beat notification cycle time may be received from each discovered device in 901 by virtue of the subscriptions established in 703. In the present example, the discovered devices are device 840 as well as devices 810 and 830, which correspond to discovered services 814 and 834.

Heart beat notifications may be received from the discovered devices in 902 by virtue of the established subscriptions. In some embodiments, heart beat notifications are received when a control point renews its subscription to a device. Device addresses and associated network interfaces may then be determined in 903 based on the received heart beat notifications. In this regard, a device may interface to a network using more than one network interface, as shown with respect to device 840 in FIG. 6. Moreover, a network address of a device may change if its DHCP lease expires or if its associated apparatus moves in and out of range of a wireless access point. It may therefore be beneficial to track network interfaces and addresses that are associated with devices so that a single device is not represented by two or more devices within the object hierarchy of control point 802.

In 904, it is determined whether any network interface or address associated with a device has changed. This determination may be based on information contained within the received heart beat notifications. If no interface or address has changed, flow returns to 903. If so, flow proceeds to 905.

Any changed address and/or network interfaces are provided to client application 806 in 905, and flow thereafter returns to 903. In some embodiments, client application 806 is thereby efficiently provided with a network interface and address of a device of interest.

Returning to process 700, device restart handling may be performed in 705 after subscriptions are established in 703. According to some embodiments, 704 and 705 may be performed contemporaneously.

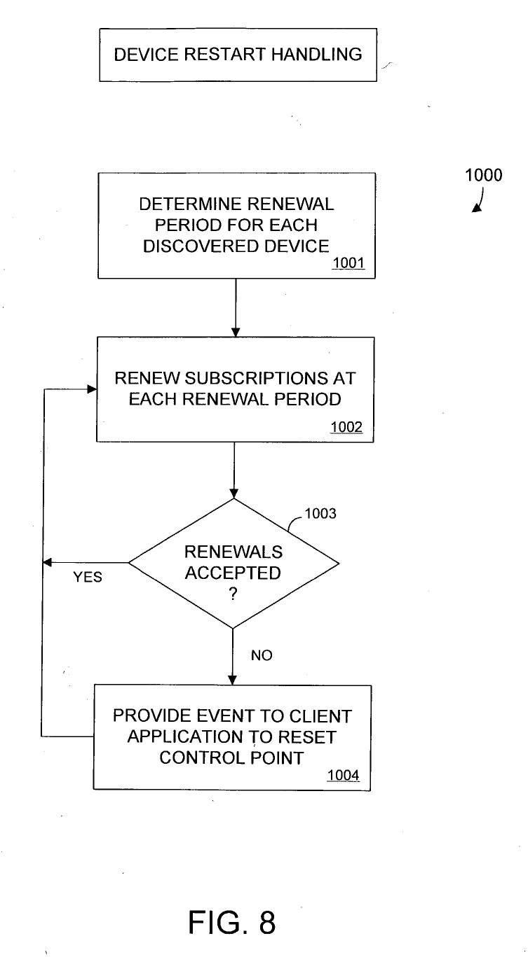

FIG. 8 is a flow diagram of process 1000 to perform device restart handling according to some embodiments of 705. A renewal period for each discovered device (e.g., devices 810, 830 and 840) is determined in 1001. In some embodiments, a renewal period refers to a period of time after which an established subscription should be renewed. Each subscription that was established in 703 is renewed in 1002 according to an associated one of the determined renewal periods.

Control point 802 may renew a subscription to a device by transmitting a renewal request to the device. The renewal request may include a subscription Id that identifies the subscription to be renewed. Next, in 1003, it is determined whether the device accepted the renewal request. Flow returns to 1002 if it is determined that the renewal request was accepted.

If the renewal request was not accepted, flow continues to 1004. In 1004, control point 802 may provide an event to client application 806 indicating that control point 802 should be reset. Resetting control point 802 may comprise one or more of restarting control point 802, resynchronizing control point 802 with the device, and other resetting procedures. Process 1000 may therefore provide client application 806 with an efficient system to handle a device of interest that was restarted.

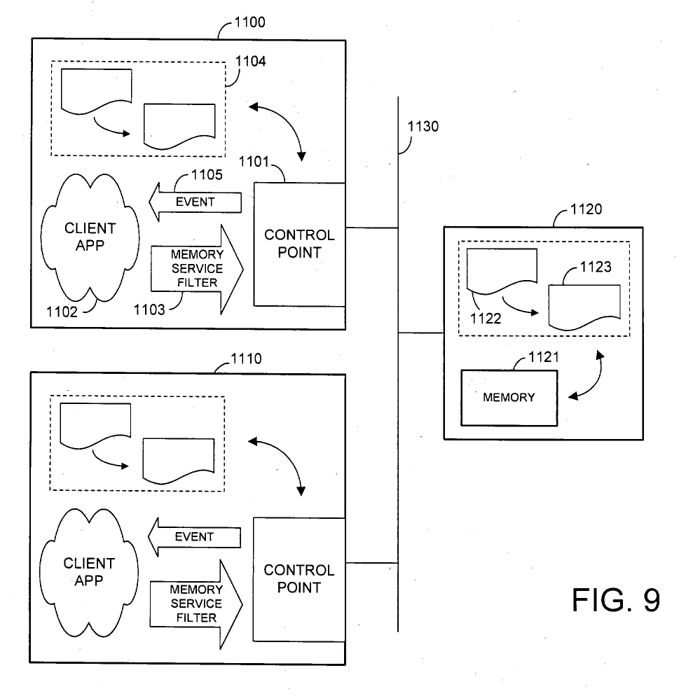

FIG. 9 illustrates an architecture for describing a memory service according to some embodiments. Apparatuses 1100, 1110 and 1120 are shown in communication with network bus 1130. In one particular example, apparatus 1100 is a compact disc player, apparatus 1110 is a television, and apparatus 1120 is a personal computer having memory 1121 such as a fixed disk.

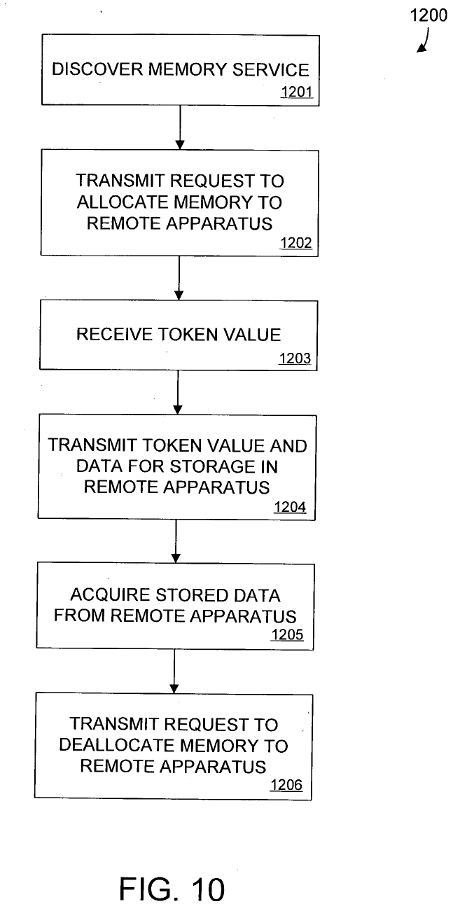

Apparatuses 1100 and 1110 may implement unshown device and service objects, or may simply implement control points as illustrated. Some embodiments of FIG. 9 may allow apparatuses 1100 and 1110 to utilize the data storage capacity of memory 1121. FIG. 10 is a diagram of process 1200 according to some of these embodiments.

A memory service is discovered by control point 1101 in 1201. Discovery may occur as described above with respect to 702. More particularly, client application 1102 may pass filter 1103 describing a desired memory service to control point 1101, and control point 1101 may publish a request including a description of the desired memory service. In the present example, memory service 1123 of device 1122 matches the description. An XML description document for device 1122 may therefore be transmitted to control point 1101.

The description document may include a pointer to a service description document describing service 1123. Control point 1101 may access the service description document and parse the document to determine that memory service 1123 provides an AllocateMemory action, a DeallocateMemory action, a SetMemory action, and a GetMemory action. Information contained in the description documents may be used to construct object hierarchy 1104. Control point 1101 may communicate with device 1122 and service 1123 through object hierarchy 1104.

Control point 1101 invokes the AllocateMemory action in 1202 to transmit a request to allocate memory to apparatus 920. A token value representing allocated memory is received from memory service 1123 in 1203. The token value may be passed as event 1105 to client application 1102.

At 1204, the token value may be transmitted along with data for storage to apparatus 1120. In a specific example, control point 1101 receives the data from client application 1102, invokes the SetMemory action, and passes the token value and the data as parameters to the action. Memory service 1123 may return a success flag if the data was successfully stored in the allocated portion of memory 1121.

The stored data may be acquired in 1205 using the GetMemory action. Again, the token value may be passed to memory service 1123 as a parameter to the GetMemory action. Also passed as parameters may be a byte-index offset from which to acquire the data, a number of bytes to acquire, and/or a desired encoding scheme. The requested data is received in 1205, and may be provided to client application 1102.

A request to deallocate the allocated memory may be transmitted to apparatus 920 in 1206. The request may comprise calling the DeallocateMemory action and passing the token value as a parameter to the function call.

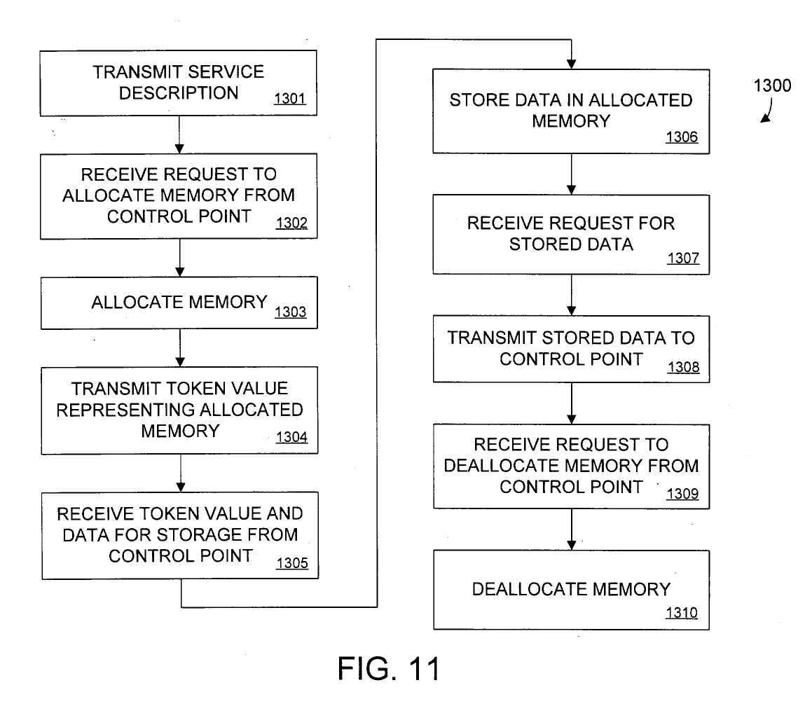

Process 1300 of FIG. 11 may be performed by memory service 1123 in response to process 1200. For example, memory service 1123 may transmit a service description in 1301 in response to a request received from control point 1101. A request to allocate a block of memory may be received from control point 1101 in 1302. As described with respect to process steps 1200, the request may comprise a call to an AllocateMemory function of memory service 1123.

Service 1123 may allocate an area of memory 1121 in response to the request in 1303. Memory 1121 may comprise one or more types of memory and may be allocated in a linear or hierarchical fashion based on optimization and capacity concerns. A token value representing the allocated memory area of memory 1121 is transmitted to control point 1101 in 1304. The token value may thereafter be received from control point 1101 in 1305 along with data to be stored in the allocated memory area. As described above, the token and data may be received as parameters to a SetMemory action supported by memory service 1123.

The received data is stored in the allocated memory area of memory 1121 in 1306. In some examples, a request is received in 1307 for some or all of the stored data via a call to a GetData action of memory service 1123. The request may include the token value and information specifying the data to retrieve from the allocated memory area. The requested data may be transmitted to control point 1101 in 1308.

Memory service 1123 may receive a request to deallocate the allocated memory in 1309. The request may comprise a call to a DeallocateMemory action of memory service 1123 in which the token value is a parameter. The area of memory 1121 is then deallocated in 1310.

Apparatus 1110 is shown in FIG. 9 to illustrate that, in some embodiments, more than one control point may utilize a single memory service. In some embodiments, apparatus 1120 stores a boot image or any other binary image such as a user interface in memory 1121. A remote control point may access these images in order to reduce storage capacity required by the apparatus in which the control point resides.

Some embodiments of memory service 1123 provide an EnumerateAllocate action, which returns a list of allocated memory portions and token values usable to access each portion. In this regard, a CurrentAllocations state variable may be used to provide such a list. Either or both of the EnumerateAllocate action and CurrentAllocations state variable may operate in conjunction with an AllocateMemory parameter that indicates whether the memory to allocate should be enumerable.

The AllocateMemory action may also include a ShareMemory Boolean argument. ShareMemory may indicate whether the memory to be allocated can be shared with control points other than the control point that called that AllocateMemory action. Other possible arguments include ShareRead and ShareWrite, which specify whether the memory to be allocated can be read (or written to) by control points other than the control point that called that AllocateMemory action.

Various actions of a memory service according to some embodiments may include a PrivateToken argument. The PrivateToken argument may be passed by a control point as a parameter to the AllocateMemory action, and may be required as a parameter to other actions of the memory service. Some uses of the PrivateToken argument may therefore allow only the control point that allocated the memory to access the memory.

Some embodiments of a memory service may comprise primitives for lock and set, mutex, semaphores, and mailboxes. Such primitives may allow shared memory to be used as a sychronization mechanism for applications and processes distribute around the network.

A memory service according to some embodiments may also advertise available memory locations. A control point may upload a binary image to an advertised location using SetMemory and invoke a Run action provided by the memory service to execute the binary image.

A memory service may also implement the UPnP Security protocol to provide secure, authenticated, access-controlled memory service. In this regard, some embodiments include arguments that encrypt data and requests transmitted between the memory service and a control point. According to one example of the latter embodiments, a memory service may define a single action that accepts an encrypted (or non-encrypted) message describing a desired memory request.

A memory service according to some embodiments may provide an AvailableBytes state variable that indicates an amount of memory that may be allocated by network control points. It may be beneficial to check a value of the AvailableBytes state variable before calling the AllocateMemory action.

Other embodiments provide structured data storage within allocated memory. Such data storage may utilize storage of a structured data description associated with the stored data. The description may comprise an XML description of parameters and parameter types. Memory service clients may access the description in order to pass structured data back and forth via a shared memory. Some embodiments of the foregoing may provide a network clipboard, in which structured data such as image files, typed variables, and the like could be stored, retrieved and processed by remote and disparate applications.

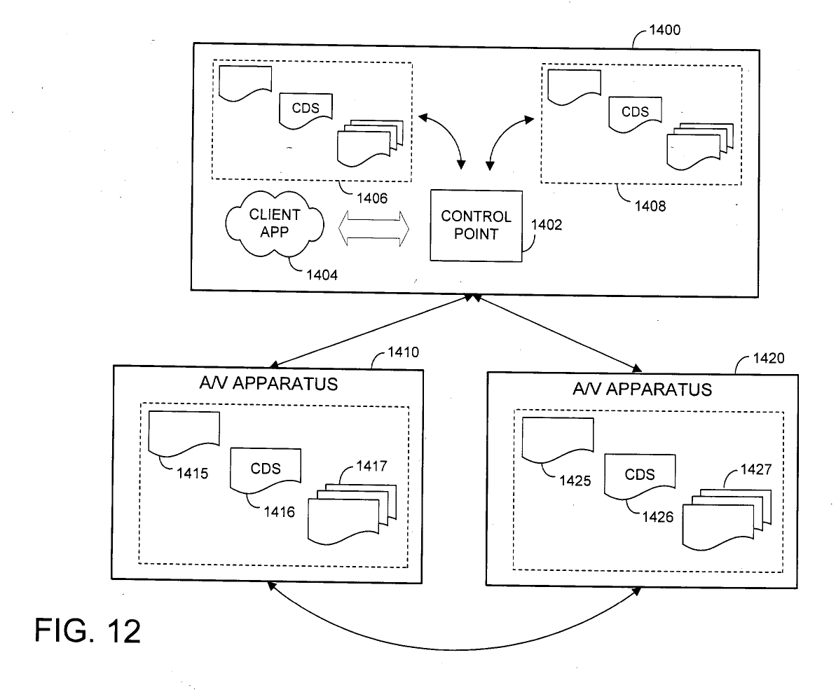

FIG. 12 illustrates a system to manage content directory services according to some embodiments. According to some examples, apparatus 1400 comprises a network hub implementing control point 1402. A/V apparatuses 1410 and 1420 respectively comprise a personal computer and a mobile mp3 player.

According to the UPnP A/V architecture specification, an A/V device may comprise a media server or a media renderer. A media server may provide media objects to a media renderer and a media renderer may render media objects that are stored locally or served from a media server. A single apparatus may implement both a media renderer A/V device and a media server A/V device.

A/V devices 1415 and 1425 are A/V media servers. A/V device 1415 of apparatus 1410 may communicate directly with A/V device 1425 of apparatus 1420. Such communication may be triggered by control point 1402 and controlled by respective A/V transport services (not shown) provided by each device.

A/V devices 1415 and 1425 respectively provide content directory service 1416 and content directory service 1426. A content directory service may provide a set of actions to enumerate the media objects that a media server can provide to a network. These actions are represented by objects 1417 and 1427, and may include Browse, UpdateObject, CreateObject, DestroyObject, ImportResource and ExportResource.

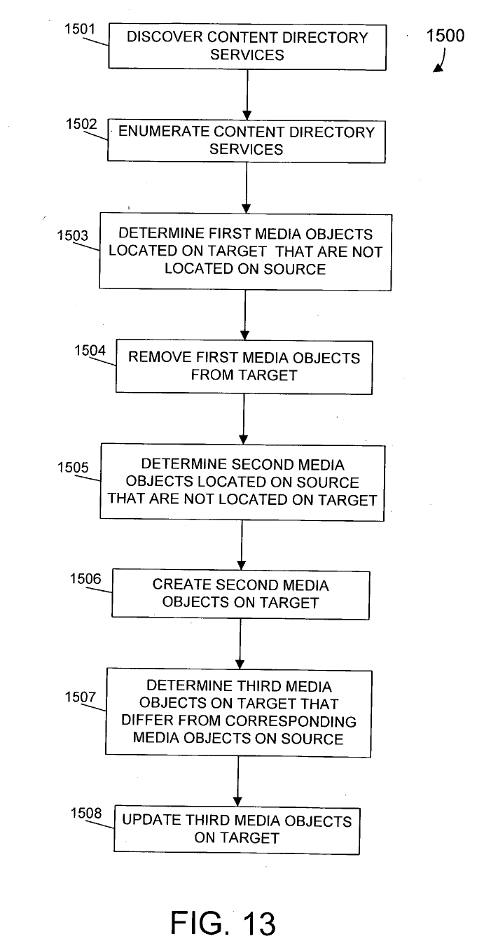

FIG. 13 is a flow diagram of process 1500 to synchronize media objects between media servers according to some embodiments. Initially, in 1501, control point 1402 discovers content directory services on a network providing discoverable services. In some embodiments, client application 1404 passes a filter describing the content directory services to be discovered. The filter may specify all available content directory services, those that provide particular content, or those that satisfy any other discoverable criteria. Using the filter, control point may receive pointers to content directory services 1416 and 1426 and build corresponding object hierarchies 1406 and 1408 as described above with respect to 702 of FIG. 5.

Control point 1402 may invoke the Browse action of each of object hierarchies 1406 and 1408 in 1502. This action provides control point 1402 with metadata describing each media object that can be served by devices 1415 and 1425. The Browse action of each of services 1416 and 1426 may be invoked simultaneously or independently. Moreover, any suitable algorithm for enumerating a hierarchical tree of objects may be employed.

Next, in 1503, control point 1402 (or client application 1404) determines first media objects that are located on A/V device 1425 but not on A/V device 1415. If a same media object is associated with a same ObjectID on both devices, such a determination may be performed by comparing the ObjectIDs of the media objects on each device. The determination may also be performed by comparing the dc:title, dc:creator, and other metadata fields associated with each media object. Custom metadata fields may also be used to specify that two media objects contain identical content.

Identical content may be determined by deriving hash values for each media object that uniquely identify their content. Depending on the hashing algorithm, the derived hash value may actually be used as the ObjectID, thereby reducing a need for custom metadata fields. Control point 1402 may download media objects from both devices in 1503 and perform bit-by-bit comparisons.

Regardless of how the first media objects are determined, they may be removed from target device 1425 in 1504. Control point 1402 may remove the objects by invoking the DestroyObject action of actions 1427. Next, in 1505, control point 1402 determines second media objects located on source device 1415 that are not located on target device 1425. This determination may proceed similarly to the determination of 1503.

Once the second media objects are determined, duplicates of the second media object are created on device 1425. In some embodiments, the second media objects are downloaded by control point 1402 and sent to an appropriate location specified by an importURI attribute of the newly-created media object's resource. In other embodiments, control point 1402 may call the ImportResource action of service 1426, which would allow device 1425 to directly acquire a specified media object from device 1415.

According to some embodiments, 1506 comprises calling the ExportResource action of service 1416, which would allow device 1415 to send a specified media object to device 1425. Some embodiments invoke the ImportResource action as described above, then invoke the ExportResource if ImportResource was not successful, then finally download the desired media objects to apparatus 1400 and upload the objects to device 1425.

In 1507, control point 1402 determines third media objects that are located on device 1425 and on device 1415, but that somehow differ. Such media objects may represent different versions of a same song, or the like. In some embodiments, media objects are associated with metadata comprising a change log. Such a log may indicate content origination and actions that have been applied thereto. Change logs of different media objects may thereby aid in determining whether two media objects are identical, different versions of a same media object, or otherwise related. According to the present example, it is assumed that the third media objects located on device 1425 are outdated and should be replaced with the corresponding media objects on device 1415.

Therefore, the third media objects located on device 1425 are updated with the content of the corresponding media objects on device 1415 in 1508. The update may comprise calling the ExportResource action of content directory service 1416 or calling the ImportResource action of content directory service 1426. In some embodiments of 1508, control point 1402 calls the DestroyObject action of content directory service 1426 to delete the outdated media object, calls the CreateObject action of service 1426, and transfers the new content to device 1425.

Process 1500 may utilize custom metadata to associate a user's or application's intentions with a media object. Sample intentions may include “synchronize”, “move”, and “copy”. Accordingly, actions performed on a media object may depend on the particular intention associated with the media object.

Process 1500 are intended to mirror the media objects of device 1415 onto device 1425. This function may be used to maintain current copies of objects on devices located on different networks. In one particular example, apparatus 1410 is an office computer and apparatus 1420 is a personal digital assistant. Device 1425 therefore maintains a current copy of selected objects from device 1415. If the personal digital assistant joins a network on which a home computer resides, the personal digital assistant may assume the role of apparatus 1410 and the home computer may assume the role of apparatus 1420. As a result, the home computer is synchronized with the office computer. The steps may be repeated in reverse if the objects are changed on the home computer.

Some embodiments include the step of removing objects transferred from device 1415 to device 1425, so as to avoid duplication. Process 1500 may also be altered so that each device includes the logical union of all media objects initially located thereon.

Process 1500 may be altered to provide desired content on target device 1425. More specifically, media objects deemed unwanted may be removed from device 1425 in 1504. Next, media objects deemed wanted may be created on device 1425 in 1506. One implementation of this embodiment could involve a personal computer as apparatus 1410 and a car stereo as apparatus 1420. Each time apparatus 1420 joined the network (e.g., by entering a home's garage), apparatus 1410 would remove songs that were created on device 1425 more than one month ago and would create other selected songs on device 1425.

Some embodiments of process 1500 may provide network load balancing by moving heavily requested media objects to less active servers. Some embodiments may provide balancing of storage resources between A/V devices, so that free disk space is maximized on participating A/V devices and/or so that infrequently-accessed objects are automatically moved from one A/V device to another A/V device that is intended to serve such objects.

In the foregoing description, numerous specific details are set forth in order to provide a thorough understanding. It will be apparent, however, to one of ordinary skill in the art that some embodiments do not include one or more of these specific details. Moreover, embodiments may include any currently or hereafter-known elements that provide functionality similar to those described above. Therefore, persons of ordinary skill in the art will recognize from this description that other embodiments may be practiced with various modifications and alterations.

What is claimed is:

1. A method for a network control point comprising:
receiving a filter from a client application, the filter describing a requested object;
discovering the requested object on a network; and
instantiating a local object corresponding to the requested object.

2. A method according to claim 1, further comprising:
interfacing with the local object to control the requested object.

3. A method according to claim 1, wherein the requested object is a device, and further comprising:
receiving a first heart beat notification associated with the device;
determining an address associated with the device based on the first heart beat notification;
providing the first address to the client application;
receiving a second heart beat notification associated with the device;
determining a changed address associated with the device based on the second heart beat notification; and
providing the changed address to the client application.

4. A method according to claim 3, further comprising:
determining a first network interface associated with the device based on the first heartbeat notification;
providing the first network interface to the client application;
determining a second network interface associated with the device based on the second heartbeat notification; and
providing the second network interface to the client application.

5. A method according to claim 3, further comprising:
subscribing to heart beat notifications issued by the device.

6. A method according to claim 1, wherein the requested object is a device, and further comprising:
obtaining subscriptions to advertisements issued by the device;
determining a renewal period associated with the device;
transmitting a request to renew the subscriptions based on the renewal period;
determining whether the request was accepted; and
providing an event to the client application to reset the control point if the request was not accepted.

7. A method according to claim 1, wherein the requested object is a device, and further comprising:
receiving a description from the device;
generating a device specification based on the description; and
providing the specification to the client application.

8. A method according to claim 7, wherein the description is an extensible markup language document.

9. A method according to claim 1, wherein the object is a first content directory service, further comprising:
discovering a second content directory service on the network;
instantiating a second local object corresponding to the second content directory service;
enumerating the content directory services; and
synchronizing media objects associated with the content directory services.

10. A method according to claim 9, wherein the synchronizing step comprises:
determining first media objects associated with the second content directory service that are not associated with the content directory service; and
creating the first media objects on the content directory service.

11. A method according to claim 10, wherein the synchronizing step further comprises:
determining second media objects associated with the content directory service that are not associated with the second content directory service; and
removing the second media objects from the content directory service.

12. A method according to claim 11, wherein the synchronizing step further comprises:
determining third media objects associated with the content directory service that differ from corresponding objects associated with the second content directory service; and
updating the third media objects based on the corresponding objects.

13. A processor-readable medium storing processor-executable process steps, the process steps comprising:
a step to receive a filter from a client application, the filter describing a requested object;
a step to discover the requested object on a network; and
a step to instantiate a local object corresponding to the requested object.

14. A medium according to claim 13, the process steps further comprising:
a step to interface with the local object to control the requested object.

15. A medium according to claim 13, the process steps further comprising:
a step to receive a first heart beat notification associated with the object;
a step to determine an address associated with the object based on the first heart beat notification;
a step to provide the first address to the client application;
a step to receive a second heart beat notification associated with the object;
a step to determine a changed address associated with the object based on the second heart beat notification; and
a step to provide the changed address to the client application.

16. A medium according to claim 13, the process steps further comprising:
a step to obtain subscriptions to advertisements issued by the object;
a step to determine a renewal period associated with the object;
a step to transmit a request to renew the subscriptions based on the renewal period;
a step to determine whether the request was accepted; and
providing an event to the client application to reset the control point if the request was not accepted.

17. A medium according to claim 13, wherein the object is a first content directory service, the process steps further comprising:
a step to discover a second content directory service on the network;
a step to instantiate a second local object corresponding to the second content directory service;
a step to enumerate the content directory services; and
a step to synchronize media objects associated with the content directory services.

18. A medium according to claim 17, wherein the step to synchronize comprises:
a step to determine first media objects associated with the second content directory service that are not associated with the content directory service;
a step to create the first media objects on the content directory service;
a step to determine second media objects associated with the content directory service that are not associated with the second content directory service;
a step to remove the second media objects from the content directory service;
a step to determine third media objects associated with the content directory service that differ from corresponding objects associated with the second content directory service; and
a step to update the third media objects based on the corresponding objects.

19. An apparatus comprising:
a fixed disk drive storing processor-executable process steps; and
a processor in communication with the memory and operative in conjunction with the stored process steps to:
receive a filter from a client application, the filter describing a requested object;
discover the requested object on a network; and
instantiate a local object corresponding to the requested object.

20. An apparatus according to claim 19, wherein the requested object is a device, and the processor further operative in conjunction with the stored process steps to:
receive a first heart beat notification associated with the device;
determine an address associated with the device based on the first heart beat notification;
provide the first address to the client application;
receive a second heart beat notification associated with the device;
determine a changed address associated with the device based on the second heart beat notification; and
provide the changed address to the client application.

21. An apparatus according to claim 20, the processor further operative in conjunction with the stored process steps to:
determine a first network interface associated with the device based on the first heartbeat notification;
provide the first network interface to the client application;
determine a second network interface associated with the device based on the second heartbeat notification; and
provide the second network interface to the client application.

22. A medium storing process steps to provide a memory service, the process steps comprising steps to provide:
an allocate memory action to send a memory allocation request to the memory service;
a set memory action to store data in allocated memory;
a get memory action to retrieve the data from the allocated memory; and
a deallocate memory action to request release of allocated memory.

23. A medium according to claim 22, the allocate memory action to transmit a token value corresponding to the allocated memory, and the set memory action, the get memory action and the deallocate memory action to receive the token value.

24. A medium according to claim 22, the process steps further comprising steps to provide:
an enumerate allocations memory action to list allocated memory segments and token values corresponding to each allocated memory segment.

25. A medium according to claim 22, the allocate memory action to allocate the memory so as to indicate whether the allocated memory is included in the list of allocated memory segments.

26. A medium according to claim 22, the allocate memory action to allocate the memory so as to allow multiple control points to access the allocated memory.

27. A system comprising:
a personal computer comprising:
a fixed disk drive storing processor-executable process steps; and
a processor in communication with the memory and operative in conjunction with the stored process steps to provide a memory service, the memory service comprising:
an allocate memory action to send a memory allocation request to the memory service;
a set memory action to store data in allocated memory;
a get memory action to retrieve the data from the allocated memory; and
a deallocate memory action to request release of allocated memory.

28. A system according to claim 27, further comprising:
a device in communication with the personal computer, the device comprising a control point to invoke the memory service.
